(19) United States
(12) Patent Application Publication
(10) Pub. No.: US 2024/0086754 A1
(43) Pub. Date: Mar. 14, 2024

(54) VERTICAL DISPLACEMENT MEASUREMENT FOR CRYOGENIC INTERFEROMETRIC STABILIZATION

(71) Applicant: IonQ, Inc., College Park, MD (US)

(72) Inventor: Sarah Margaret KREIKEMEIER, San Diego, CA (US)

(21) Appl. No.: 18/145,701

(22) Filed: Dec. 22, 2022

Related U.S. Application Data
(60) Provisional application No. 63/292,981, filed on Dec. 22, 2021.

(51) Int. Cl. G06N 10/40; F17C 3/08

(52) U.S. Cl. CPC G06N 10/40; F17C 3/085; F17C 2223/0161

(57) ABSTRACT

Aspects of the present disclosure relate generally to systems and methods for use in the implementation and/or operation of quantum information processing (QIP) systems, and more particularly, to the implementation and operation of vertical displacement measurement techniques for cryogenic interferometric stabilization in QIP systems.

### CROSS-REFERENCE TO RELATED APPLICATION

This application claims the benefit of U.S. Provisional Patent Application No. 63/292,981, filed Dec. 22, 2021, the entire contents of which are hereby incorporated by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of the implementation and operation of vertical displacement measurement techniques for cryogenic interferometric stabilization in QIP systems.

In an example implementation a quantum information processing (QIP) system includes a cryostat, an interferometer sensor, and a controller. The cryostat includes a nanopositioning system and a viewport. The nanopositioning system includes a movable platform configured to reposition one or more components coupled to the movable platform. The viewport is aligned with at least a portion of the nanopositioning system. The interferometer sensor is aligned with the viewport and configured to measure a displacement of the movable platform. The controller includes a processor and a memory. The memory includes instructions executable by the processor to: receive information indicative of the measured displacement of the movable platform from the interferometer sensor and generate a repositioning signal configured to adjust the movable platform based on the information indicative of the measured displacement.

In another example implementation a nanopositioning system configured for performing displacement measurements includes a base and a platform. The base includes an optic. The platform is configured to be repositioned relative to the base. The platform includes a first surface configured to support one or more components, a second surface opposite the first surface, a mounting arm coupled to the platform at or proximate the second surface, and one or more optics coupled to the mounting arm. The optic coupled to the base and the one or more optics coupled to the mounting arm are configured to form an optical path for a beam produced by an interferometer sensor. The optical path is configured to be used to determine a displacement of the platform in a vertical direction relative to an orientation of the cryostat.

In another example implementation, a method for performing vertical displacement measurements for cryogenic interferometric stabilization in quantum information processing (QIP) systems includes: aligning an interferometer sensor with a nanopositioning system positioned within a cryostat of the QIP system; producing, with the interferometer sensor, a beam that travels along an optical path produced by one or more optics coupled to a movable platform of the nanopositioning system; receiving, with the interferometer sensor, a reflected beam from the optical path; determining a length of the beam path of the reflected beam; and determining a displacement of the movable platform based on the length of the beam path of the reflected beam.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of a top view of a nanopositioning system inside a cryostat in accordance with aspects of this disclosure.

FIG. 5A illustrates a cross-sectional view of the nanopositioning system taken along line 5-5 of FIG. 4 and showing vertical displacements of components of the nanopositioning system in accordance with aspects of this disclosure.

FIG. 5B illustrates a cross-sectional view of the nanopositioning system taken along line 5-5 of FIG. 4 and showing horizontal displacements of components of the nanopositioning system in accordance with aspects of this disclosure.

FIG. 6 illustrates an example of the nanopositioning system of FIG. 4 that includes a system configured to measure displacement in the vertical direction in accordance with aspects of this disclosure.

FIG. 7 illustrates an example of a beam path of a configuration of the system of FIG. 6 after vertical displacement of a top plate of the nanopositioning system relative to the configuration shown in FIG. 6 in accordance with aspects of this disclosure.

FIG. 8 illustrates an example beam path of a configuration of the system of FIG. 6 after horizontal displacement of a top plate of the nanopositioning system relative to the configuration shown in FIG. 6 in accordance with aspects of this disclosure.

FIG. 9 illustrates an example feed-forward control method in accordance with aspects of this disclosure.

FIG. 10 illustrates an example feedback control method in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Some QIP systems may be implemented using cryogenic environments (e.g., cryostats or cryogenic chambers) to improve operational performance. One example is for operations to be performed at environments of having temperatures of approximately 4 Kelvin. Environments having temperatures of approximately 4 Kelvin can be achieved by having one or more stages. For example, the cryogenic environment may include a first stage or first environment at 40 Kelvin, and a second stage or second environment within the first stage at 4 Kelvin. Other implementations with more than two stages are also possible.

It is advantageous for high performance laser systems in QIP systems that include cryogenic chambers to be able to compensate for vibrations that can occur within the cryostat, for example by having adjustment capabilities having enough degrees of freedom to maintain alignment of components inside the cryostat after the components inside the cryostat are cooled down to operating temperatures. Such components may include one or more optical components. Such alignments may be between components within the cryostat or between a component inside of the cryostat and a component outside of the cryostat. Systems within the cryostat undergo thermal contraction as the cryostat cools to operating temperatures and will be exposed to vibrations produced by the pumping of gaseous or liquid helium necessary for maintaining the cryogenic environment. In some aspects, operating temperatures may be approximately 40 K. In some aspects, operating temperatures may be approximately 4K.

In many applications, it is advantageous for optical components installed within a cryostat and to have precise alignment and stability relative to other internal or external components. Nanopositioning systems can be installed inside of the cryostat to provide the necessary degrees of freedom to perform alignment or re-alignment of the optical components (e.g., to compensate for displacements due to vibrations of the cryostat, thermal contraction of components at cryogenic temperatures, and so forth). Closed-loop nanopositioning systems with integrated sensors are typically limited in their resolution and are unable to achieve the nanometer precision needed for interferometric stability. For example, nanopositioning systems that include resistive linear sensors cannot provide distance measurements with resolutions below 1 micron (μm). Interferometer sensors can be used to measure the positions of the components inside the cryostat for high-precision, closed-loop positioning and vibration monitoring. For example, in some aspects, the interferometer sensors may be configured to provide distance measurements below 1 In some aspects, the interferometer sensors may be configured to provide distance measurements below one nanometer (nm).

Interferometer sensors can be aligned to a reflective reference surface inside the cryostat for displacement monitoring. It is advantageous to install interferometer sensors on the exterior of the cryostat to limit the optical alignment challenges that arise if the sensors are installed inside the cryogenic environment. For example, thermal contraction can cause misalignments as the cryostat is cooled to its operational temperature range. An advantage of positioning the interferometer sensor head(s) outside of the cryostat is that the interferometer sensor head can be repositioned relative to the reflective target positioned within the cryostat chamber after the reflective target has cooled to cryostatic temperatures to correct any misalignment of the interferometer sensor head and the reflective target that has occurred during cooling.

Another challenge with mounting interferometer sensors on the exterior of the cryostat is that optical viewport access to the interior of the cryostat is often minimized to reduce the thermal radiation transferred into the chamber of the cryostat through the optical viewport(s). In order to obtain vertical position measurements (as opposed to horizontal position measurements), either a vertically oriented viewport may be positioned directly above the internal components of interest or the interferometer sensor is configured to have an optical design that allows for vertical position measurement using a horizontal-axis viewport. As used herein, the phrase “vertical” means a vertical direction relative to an orientation of the cryostat. As used herein, the phrase “horizontal” refers to a direction that is orthogonal to the vertical direction.

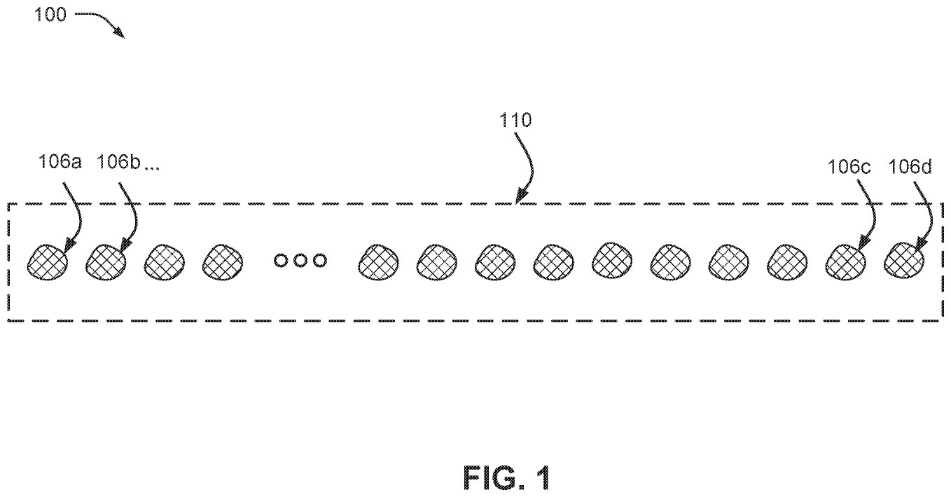

Solutions to the issues described above are explained in more detail in connection with FIGS. 1-10, with FIGS. 1-3 providing a background of QIP systems or quantum computers, and more specifically, of atomic-based QIP systems or quantum computers. This disclosure describes optical path configuration techniques that enable high-resolution vertical displacement measurements of a component installed inside a cryostat for the purpose of displacement monitoring and stabilization. The optical path uses a horizontal-axis viewport, yet it is insensitive to displacement changes in the horizontal directions. This configuration is advantageous because such a system allows the component of displacement in the vertical direction to be determined independently of any other directions of motion of the component.

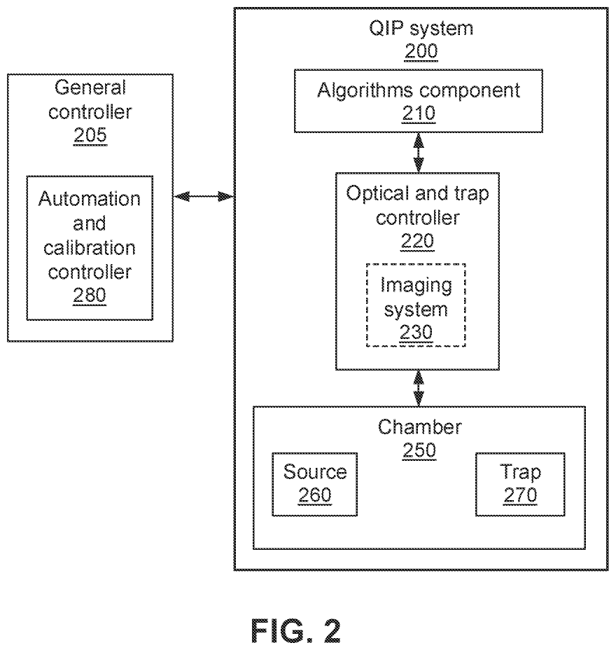

FIG. 1 illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

In some instances, to improve operational performance, the chain 110 may be placed inside a cryogenic environment such as the ones described herein.

FIG. 2 is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

For example, at least parts of the chamber 250 may operate under cryogenic conditions. In one example, the chamber 250 may be a cryostat or comprise a cryostat to provide specific cryogenic conditions. The chamber 250 may support one or more stages. In one example, the chamber 250 may support a stage at 4 Kelvin. In another example, the chamber 250 may support a first stage or first environment at 40 Kelvin, and a second stage or second environment within the first stage at 4 Kelvin.

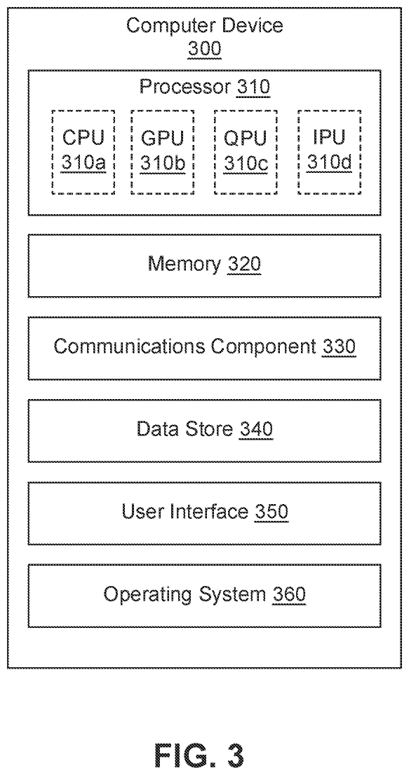

Referring now to FIG. 3, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, this disclosure describes optical path configuration techniques that enable high-resolution vertical displacement measurements of a component installed inside a cryostat. Such measurements may be used for displacement monitoring of components inside the cryostat and/or stabilization of components inside the cryostat. The optical path uses a horizontal-axis viewport, yet the optical path is insensitive to displacement changes in the horizontal directions. Thus, the techniques described herein may be used for closed-loop monitoring of a vertical cryogenic positioner or for vibration stabilization in the vertical direction. An interferometer sensor is used in this stabilization method due to the high resolution and accuracy needed to measure the cryostat's vibration levels and to achieve interferometric stability.

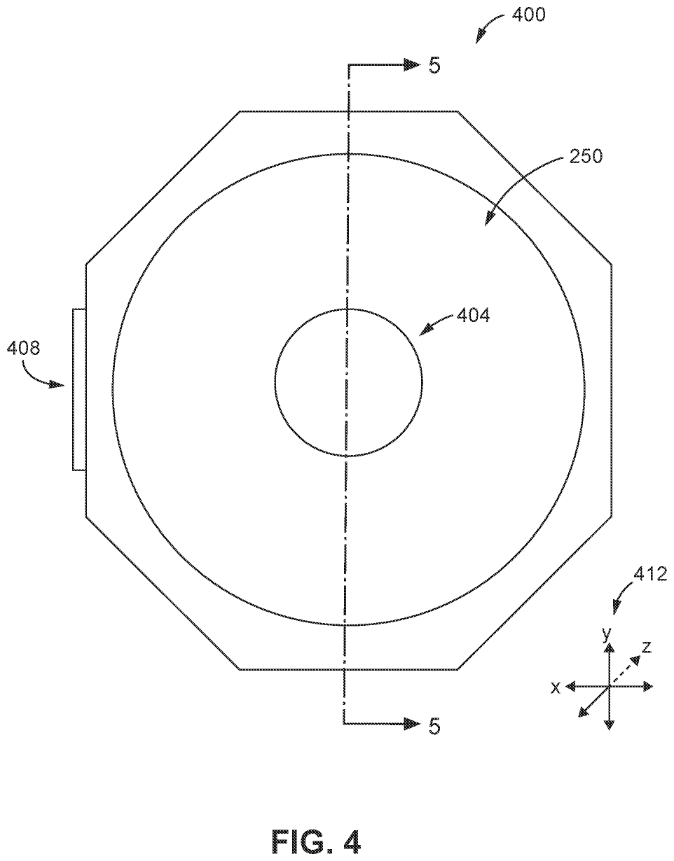

FIG. 4 illustrates an example of a top view of a cryostat system 400 including the cryogenic chamber 250, i.e., the cryogenic chamber 250 is the chamber or three-dimensional space within the cryostat system 400. As also shown, a nanopositioning system 404 is positioned inside the cryogenic chamber 250 of the cryostat 400. The cryostat 400 further includes a horizontal viewport 408 (or more generally referred to as a viewport) configured to allow the cryogenic chamber 250 to be viewed from outside of the cryostat 400. In an example aspect, the nanopositioning system 404 is configured to move in X-, Y-, and Z-axis directions shown in the coordinate system 412. The nanopositioning system 404 is also configured to rotate about the X-, Y-, and Z-axis directions shown in the coordinate system 412. As shown herein, the X and Y-axis directions are in the same plane as of FIG. 4 and the Z-direction extends out of the plane in an orthogonal direction relative to the X-Y plane as shown in FIG. 4. The vertical position (e.g., position in the direction of the Z-axis of the coordinate system of FIG. 4) of the nanopositioning system 404 may be monitored via the horizontal viewport 408. The optical path described herein can be used to monitor a vertical position of the nanopositioning system 404 when the nanopositioning system 404 is visible through the horizontal viewport 408.

In general, it is noted that the X-, Y-, and Z-axes of the coordinate system 412 are relative directions (e.g., first, second and third directions) that are orthogonal to each other. These axes are used to describe the relative horizontal positioning (e.g., in the X-Y plane) and the relative vertical positioning (e.g., in the Z-axis direction orthogonal to the X-Y plane). More generally, it can be considered that the nanopositioning system 404 moves in a direction that is orthogonal to a cross-sectional plane of the cryogenic chamber 250, which in this example is the X-Y plane. However, it should be considered that the horizontal and vertical positions and directions as described herein are relative to the overall orientation of the cryostat 400.

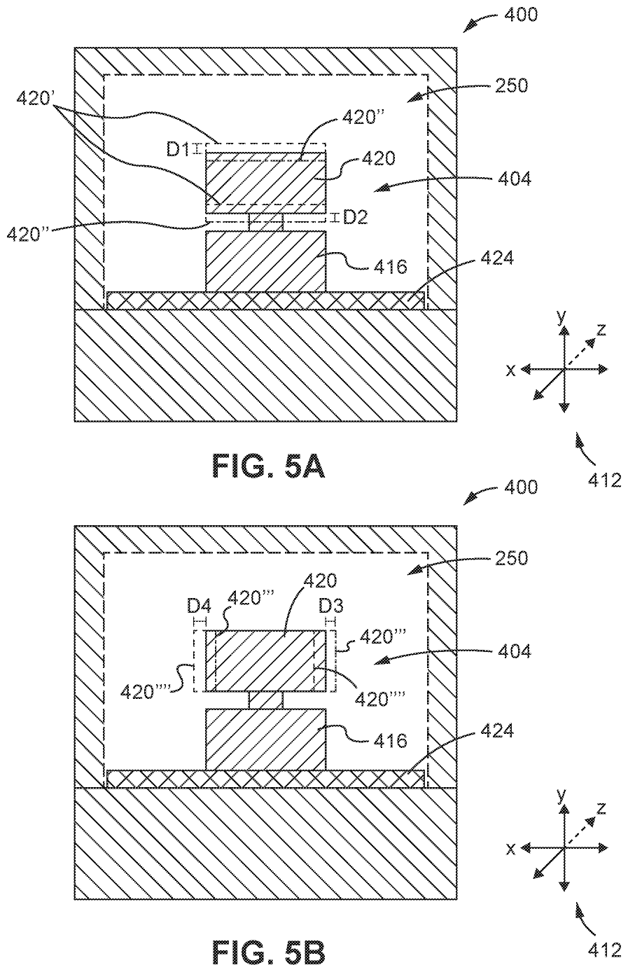

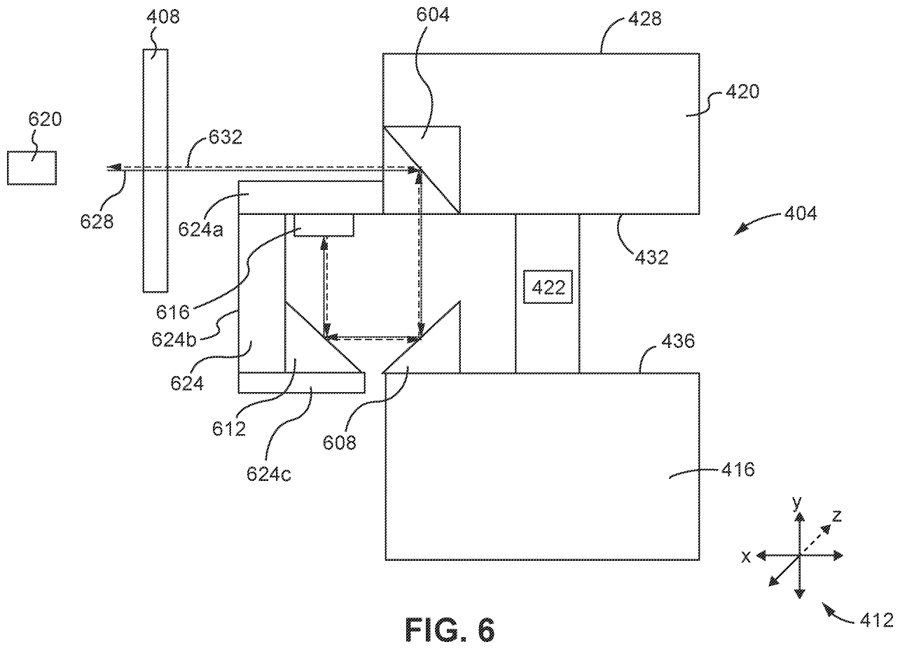

FIGS. 5A and 5B illustrate cross sectional views of the cryostat 400 and nanopositioning system 404 taken along line 5-5 of FIG. 4, e.g., in the X-Z plane of the coordinate system 412. As shown in FIGS. 5A and 5B, the nanopositioning system 404 includes a base 416, a top plate or movable platform 420, and one or more actuators 422 (e.g., as shown in FIG. 6). More particularly, as shown in FIG. 6, the one or more actuators 422 are configured to reposition the top plate 420 horizontally (FIG. 5B) and/or vertically (FIG. 5A) relative to the base 416 (e.g., along any of the X-, Y-, and Z-axes of the coordinate system 412 and/or rotation about any of the X-, Y-, and Z-axes of the coordinate system 412). The base 416 may be mounted to a stage 424 of the cryostat 400. The stage 424 may be the first stage of the cryostat, which has a temperature of approximately 40 Kelvin or the second stage of the cryostat, which has a temperature of approximately 4 Kelvin. The top plate 420 has a first surface 428, on which one or more components may be mounted, and a second surface 432 opposite the first surface 428. Such components may be or include one or more optical components.

FIG. 5A illustrates vertical movement (e.g., movement along the Z-axis direction of the coordinate system 412) of the nanopositioning system 404. For example, lines 420′ indicate a position of the top plate 420 that has been moved a distance D1 in the +Z direction. Lines 420″ indicate a position of the top plate 420 that has been moved a distance D2 in the −Z direction. FIG. 5B illustrates horizontal movement (along the X-axis direction of the coordinate system 412) of the nanopositioning system 404. For example, lines 420′″ indicate a position of the top plate 420 that has been moved a distance D3 along the +X-axis direction. Lines 420″″ indicate a position of the top plate 420 that has been moved a distance D4 along the −X-axis direction. Systems and methods to control the vertical movement of the top plate 420 (e.g., along the Z-axis direction of the coordinate system 412) using an interferometer sensor and a horizontal viewport such as the viewport 408 (e.g., positioned along the X-axis direction of the coordinate system 412) are described herein.

FIG. 6 illustrates an example measurement system 600 configured to measure vertical displacements (e.g., along the Z-axis direction) of the top plate 420. It should be appreciated that the measurements determined by the measurement system 600 are not impacted by displacements in directions orthogonal to the Z-axis direction, such as the horizontal direction (e.g., along the X-axis direction and/or the Y-axis direction). The measurement system 600 includes a first optic 604, a second optic 608, a third optic 612, a fourth optic 616, and an interferometer sensor 620 positioned outside of the cryostat 400 and that is aligned with the horizontal viewport 408. The third and fourth optics 612, 616 are coupled to a mounting arm 624. The mounting arm 624 is coupled to the top plate 420. In the illustrated configuration, the mounting arm 624 is substantially C-shaped and has a first portion 624a that is substantially parallel to the second surface 432 of the top plate 420, a second portion 624b that is orthogonal to the first portion 624a, and a third portion 624c that is parallel to the first portion 624a. It is noted that the mounting arm 624 can have other cross sectional shapes (e.g., U or V shapes) in alternative aspects as would be appreciated to one skilled in the art.

In the configuration shown herein, the optics 604-612 are right angle prisms. In the configuration shown herein, the fourth optic 616 is a mirror. In one aspect, the mirror may be substantially flat. The optics 604-612 are configured to bend the beam produced by the interferometer sensor 620 such that a beam produced by the interferometer sensor 620 in the X-axis direction (e.g., horizontal direction) can detect displacements that occur in the Z-axis direction (e.g., vertical direction). The optics 604-612 are oriented such that the portion of the beam redirected by the optic 616 can return to (and be detected by) the interferometer sensor 620. As shown in FIG. 6, the first optic 604 is coupled to or near the second surface 432 of the top plate 420. The second optic 608 may be coupled to a top surface 436 of the base 416, such that the second optic 608 does not move when the top plate 420 moves. The first and second optics 604 are aligned in the direction of motion (e.g., in the Z-axis direction of the coordinate system 412). More particularly, the propagation axis of each of the first and second optics 604 can be aligned in the Z-axis direction in this example aspect. In addition, the third optic 612 is coupled to the second and third portions 624a, 624b of the mounting arm 624 and is aligned with the second optic 608 along the X-direction of the coordinate system 412. The fourth optic 616 is coupled to the arm 624 and is aligned with the third optic 612 along the Z-axis direction. In some aspects, the first, third, and/or fourth optics 604, 612, 616 may be combined in a single optic.

Since the mounting arm 624 is coupled to the top plate 420, motion of the top plate 420 relative to the base 416 moves the first optic 604, the third optic 612, and the fourth optic 616 relative to the second optic 608 in Z-axis direction. Since this relative motion of the first, third, and fourth optics 604, 612, 616 relative to the second optic 608 is in the Z-axis direction, the measurement system 600 can detect displacement of the top plate 420 relative to the base 416 in the Z-axis direction. However, the first, third, and fourth optics 604, 612, 616 are configured such that motion of the top plate 520 in the X-axis direction is not detected by the measurement system 600 (e.g., the measurement system 600 is insensitive to displacements in the X-axis direction). This is advantageous because the system 600 can determine vertical component of the displacement the top plate 420 without the influence of motion and/or displacements of the top plate 420 in other directions. As a result, such precise measurement provides for more accurate control of the position of the top plate 420. For configurations in which the nanopositioner system X can translate in more than one direction, it is beneficial to have the displacements of all of the directions traveled independently measured to avoid misinterpreting and/or mixing the sensed displacements due to motions in each of the directions traveled. Independently measuring the displacements in all of the directions of motion of the top plate 420 can result in a system 600 that can accurately resolve the components of motion and/or displacement that occur along and/or about the various axes of the coordinate system 412. This is advantageous relative to systems which cannot accurately determine the motion and/or displacement along the various axes of the coordinate system 412. Such systems may instead rely on either approximations to estimate motion and/or displacement along such axes. Alternatively, such systems may move the components along each axis separately.

With continued reference to FIG. 6, the interferometer sensor 620 is mounted outside of the cryostat 400 and oriented relative to the cryostat 400 such that a beam produced by the interferometer sensor 620 can travel through the viewport 408. A path of the beam produced by the interferometer sensor 620 is shown by the solid line 628. The optics 604-612 are configured to fold the beam produced by the interferometer sensor 620 such that the beam contacts fourth optic 616. For example, as shown by the solid line 628, the beam exiting the interferometer sensor 620 is substantially parallel to the X-axis direction until the beam contacts the first optic 604. As shown by the line 628, the first optic 604 deflects the beam substantially 90 degrees towards the second optic 608. The second optic 608 deflects the beam substantially 90 degrees towards the third optic 612. The third optic deflects the beam substantially 90 degrees toward the fourth optic 616.

The fourth optic 616 reflects the beam produced by the interferometer sensor 620. A path of the reflected beam is shown by the dashed line 632. As shown by the dashed line 632, the fourth optic 616 reflects the beam towards the third optic 612. The third optic 612 deflects the beam substantially 90 degrees towards the second optic 608. The second optic 608 deflects the beam substantially 90 degrees towards the first optic 604. The first optic 604 deflects the beam substantially 90 degrees towards the interferometer sensor 620.

As described in greater detail below, the interferometer sensor 640 and/or a controller such as the general controller 205 and/or the optical and trap controller 220 are configured to determine a total length of the path of beam produced by the interferometer sensor 640 (e.g., line 628) and the length of the path of the reflected beam (e.g., line 632). The interferometer sensor 640 and/or the controller 205, 220 are configured to determine a displacement of the top plate 420 relative to the base 416 only in the vertical direction of the nanopositioning system 404 based on the difference between a target path length and the length of the path of the reflected beam. In some aspects, the target path length may be the length of the reflected beam when the top plate 420 is in a predefined reference position with regard to the base 416. In some aspects, the target path length may be the length of the reflected beam measured at a particular time.

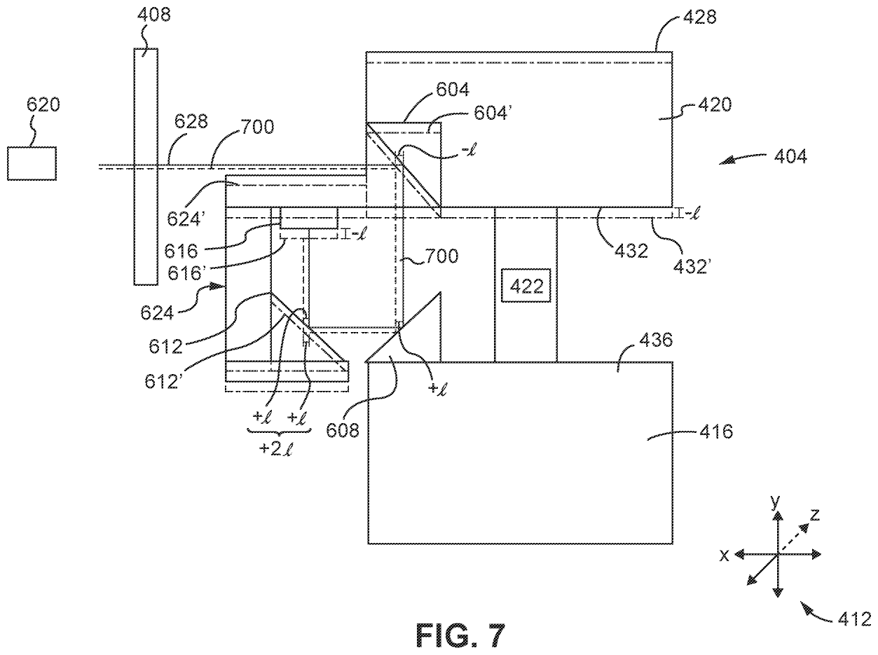

FIG. 7 illustrates an example configuration of the nanopositioning system 404 after the top plate 404 has been displaced a distance − [symbol] in a vertical direction (e.g., the −Z-axis direction of the coordinate system 412) relative to the example configuration of FIG. 6. Like numbering has been used to indicate like parts. Dashed lines and the “′” symbol are used to indicate the displaced positions of the components of the nanopositioning system 404 and the measurement system 600.

As shown in FIG. 7, the solid line 628 illustrates the baseline optical path length, and the dashed line 700 indicates the optical path length after the displacement= [symbol] in the −Z-axis direction. The change in the beam path length after the vertical displacement is equal and opposite to the vertical displacement of the top plate 404. For example, the difference in beam length (e.g., Δ₁) between the interferometer sensor 620 and the first optic 604′ is [symbol] shorter (e.g., Δ₁=− [symbol] ) than the distance between the interferometer sensor 620 and the first optic 604. The difference in beam length (e.g., Δ₂) between the first optic 604′ and the second optic 608′ is [symbol] longer than the beam length between the first optic 604 and the second optic 608 (e.g., Δ₂=− [symbol] ). The difference in beam length (e.g., Δ₃) between the second optic 608′ and the third optic 612′ is 2 [symbol] longer than the beam length between the second optic 608 and the third optic 612 (e.g., Δ₃=2 [symbol] ). The difference in beam length (e.g., Δ₄) between the third optic 612′ and the fourth optic 616′ is [symbol] shorter than the beam length between the third optic 612 and the fourth optic 616 (e.g., Δ₄=− [symbol] ). The total change in beam length due to the displacement of the top plate 404′ relative to the position shown in FIG. 6 (e.g., Δ_{beam path}) is given by the equation

Δ_{beam path}=Δ₁+Δ₂+Δ₃+Δ₄ (1)

Substituting the values for Δ₁, Δ₂, Δ₃, Δ₄ into Equation (1) yields

Δ_{beam path}=− [symbol] + [symbol] +2 [symbol] − [symbol] = [symbol] .

Therefore, a vertical displacement of the top plate 420 of the nanopositioning system 404 results in a change in the length of the optical path detected by the interferometer sensor 620 outside the cryostat 400. Therefore, the change in the length of the optical path detected by the interferometer sensor 620 due to displacement of the top plate 420 can be used as a control signal for dynamically positioning or repositioning the top plate 420 since the precise position of the top plate 420 can be monitored by the interferometer sensor 620, the general controller 205, and/or the optical and trap controller 220. For example, in some aspects, the interferometer sensors may be configured to provide distance measurements below 1 μm. In some aspects, the interferometer sensors may be configured to provide distance measurements below one nanometer (nm).

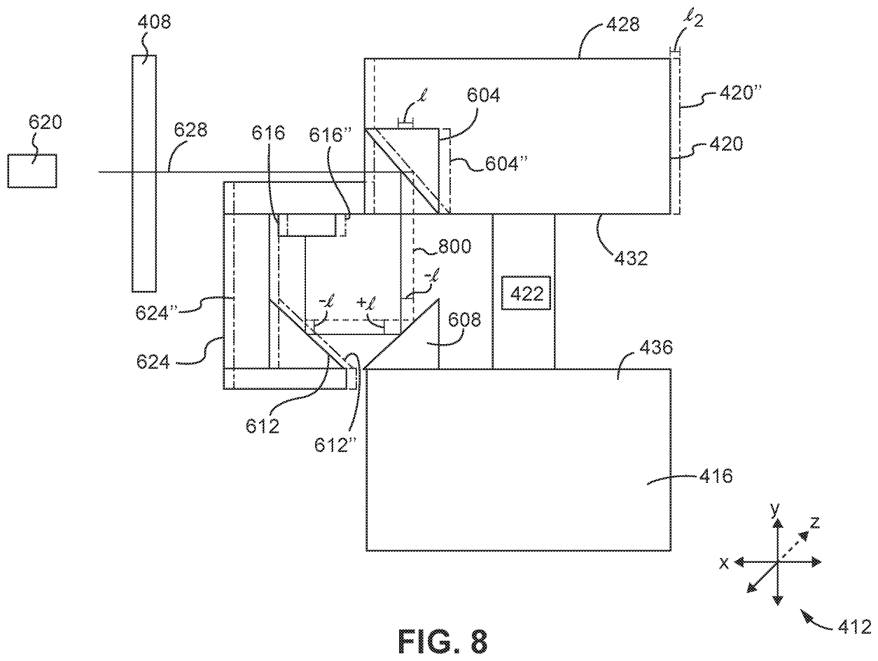

FIG. 8 illustrates an example configuration of the nanopositioning system 404 after the top plate 404 has been displaced a distance [symbol] in a horizontal direction (e.g., the +X-axis direction of the coordinate system 412) relative to the example configuration of FIG. 6. Like numbering has been used to indicate like parts. Dashed lines and the “″” symbol are used to indicate the displaced positions of the components of the nanopositioning system 404 and the measurement system 600.

As shown in FIG. 8, the solid line 628 illustrates the baseline optical path length, and the dashed line 800 indicates the optical path length after the displacement= [symbol] in the +X-axis direction of the coordinate system 412. The length of the beam path does not change due to the horizontal displacement. For example, the difference in beam length (e.g., Δ₁) between the interferometer sensor 620 and the first optic 604″ is [symbol] longer (e.g., Δ₁=+ [symbol] ) than the distance between the interferometer sensor 620 and the first optic 604. The difference in beam length (e.g., Δ₂) between the first optic 604″ and the second optic 608″ is [symbol] longer than the beam length between the first optic 604 and the second optic 608 in the Z-axis direction and is [symbol] shorter in the X-axis direction (e.g., Δ₂=− [symbol] ). The difference in beam length (e.g., Δ₃) between the second optic 608″ and the third optic 612″ is [symbol] shorter than the beam length between the second optic 608 and the third optic 612 (e.g., Δ₃=− [symbol] ). The difference in beam length (e.g., Δ₄) between the third optic 612″ and the fourth optic 616″ is the same as the beam length between the third optic 612 and the fourth optic 616 (e.g., Δ₄=0). The total change in beam length due to the displacement of the top plate 404″ relative to the position shown in FIG. 6 (e.g., Abeam path) is given by Equation (1). Substituting the values for Δ₁, Δ₂, Δ₃, Δ₄ into Equation (1) yields Δ_{beam path}= [symbol] + [symbol] − [symbol] − [symbol] =0.

In the displacement illustrated in FIG. 8, the beam path length is the same before and after the horizontal displacement. As such, a horizontal displacement of the top plate 404″ does not result in a change in the optical path detected by the interferometer sensor 620 outside of the cryostat 400. Therefore, the measurement system 600 is insensitive to displacements in the horizontal direction.

Although the measurement system 600 is described with regard to the cryostat 400 in the example embodiments described in detail herein, in other aspects, the measurement system 600 can be used in other spatially-constrained systems and/or configurations. For example, in some aspects, the measurement system 600 to determine displacements in a first direction from a viewpoint, window, opening, etc., in a wall or housing in a second directional substantially orthogonal to a field of view of the viewpoint, window, opening, etc. in the wall or housing. In some aspects, the first direction may be a vertical direction relative to the nanopositioning system 404.

The techniques described herein for monitoring cryogenic vibrations can be used for the implementation of either feedback or feed-forward control to null (e.g., compensate for) the impact of the vibration on components mounted inside of the cryostat 400 for interferometric stabilization.

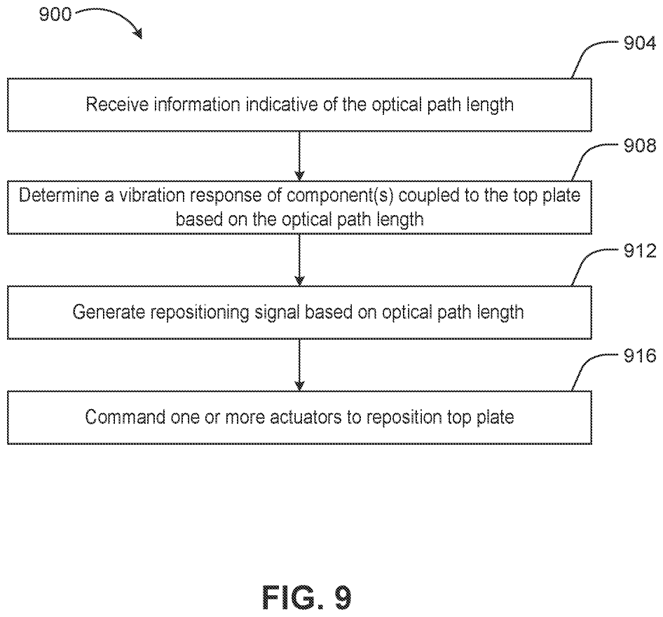

In some implementations, the optical and trap controller 220 and/or the general controller 205 may be configured to use feed-forward control is used to reject disturbances in the QIP system 200 by directly adjusting the system in a predetermined way based on the measurement of the disturbance. Example disturbances may include vibrations of the cryostat 400, displacements due to thermal contraction as components cool to cryogenic temperatures, and so forth. An example feed-forward control method 900 is illustrated in FIG. 9. For example, at 904, the controller 205, 220 may receive information indicative of the optical path length from the interferometer sensor 640. At 908, the controller 205, 220 may determine a vibration response of the component(s) coupled to the top plate 420 based on the information indicative of the optical path length. At 912, the controller 205, 220 may generate a repositioning signal based on the optical path length. At 916, the controller 205, 220 may command the one or more actuators 422 to reposition the top plate 420 based on the optical path length. Since the vibration response of components installed inside the cryostat 400 are easily measured and on a long enough time scale for corrective actions to be implemented, feed-forward control can be used for nulling the relative displacements between ambient and cryogenic operating environments in an example aspect. Moreover, since the frequency spectrum and amplitude of the cryostat vibrations are relatively stable, feed-forward control can be compensated with amplitude and frequency changes caused by vibrations because the QIP system's response to the vibrations can be made linear and well-defined in an example aspect.

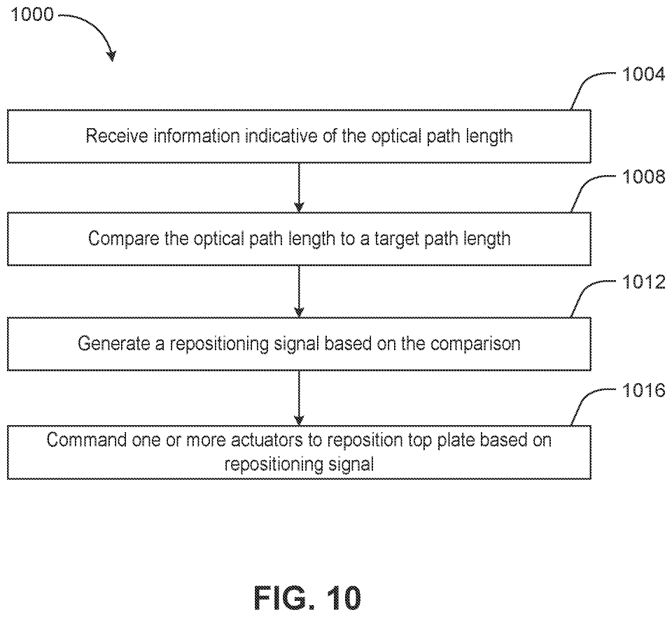

In some implementations, the controller 205, 220 may be configured to use may also use feedback control, which measures the disturbance's effect on an error signal and uses the effect on the error signal to implement corrective measures on the system's input signals to reject the disturbance. An example feedback control method 1000 is illustrated in FIG. 10. For example, at 1004, the controller 205, 220 may receive information indicative of the optical path length from the interferometer sensor 640. At 1008, the controller 205, 220 may compare the received optical path length to a target path length. At 1012, the controller 205, 220 may generate a repositioning signal based on the comparison. At 1016, the controller 205, 220 may command the one or more actuators 422 to reposition the top plate 420 based on the repositioning signal.

The implementation of feedback or feed-forward control may depend on the location of the target surface that the sensor measures.

Moreover, the techniques described herein for feedback or feed-forward control may be implemented using a controller (e.g., hardware and/or firmware) that may be part of, for example, the optical and trap controller 220 and/or the general controller 205 (e.g., part of the automation and calibration controller 280). The feedback or feed-forward control may also be implemented using an independent controller (not shown) that is part of the QIP system 200 but used either solely or mostly for adjusting cryogenic vibrations.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system comprising:
a cryostat comprising:
a nanopositioning system comprising a movable platform configured to reposition one or more components coupled to the movable platform;
a viewport aligned with at least a portion of the nanopositioning system;
an interferometer sensor aligned with the viewport and configured to measure a displacement of the movable platform; and
a controller configured to:
receive information indicative of the measured displacement of the movable platform from the interferometer sensor; and
generate a repositioning signal configured to adjust the movable platform based on the information indicative of the measured displacement.

2. The QIP system of claim 1, wherein the movable platform is displaced in a displacement direction and wherein a field of view of the viewport is orthogonal to the displacement direction.

3. The QIP system of claim 2, wherein the interferometer sensor is not configured to measure the displacement of the movable platform in at least one direction orthogonal to the displacement direction.

4. The QIP system of claim 2, wherein the displacement direction is a vertical direction relative to an orientation of the cryostat.

5. The QIP system of claim 4, wherein the interferometer sensor is insensitive to displacements of the movable platform in a horizontal direction that is orthogonal to the vertical direction.

6. The QIP system of claim 1, wherein the nanopositioning system comprises one or more optics configured to bend a beam produced by the interferometer sensor and an optic configured to reflect the beam produced by the interferometer sensor.

7. The QIP system of claim 6, wherein the nanopositioning system comprises a base coupled to a portion of the cryostat and the one or more optics include at least one optic coupled to the movable platform and an optic coupled to the base.

8. The QIP system of claim 7, wherein displacement of the movable platform is configured to cause displacement of the at least one optic coupled to the movable platform relative to the optic coupled to the base, thereby changing a length of the beam produced by the interferometer sensor.

9. The QIP system of claim 1, wherein the controller is configured to:
compare the length of the reflected beam to a target beam length; and
generate the repositioning signal based on the comparison.

10. A nanopositioning system configured for performing displacement measurements, the nanopositioning system comprising:
a base including an optic;
a platform configured to be repositioned relative to the base, the platform comprising:
a first surface configured to support one or more components;
a second surface opposite the first surface;
a mounting arm coupled to the platform at or proximate the second surface; and
one or more optics coupled to the mounting arm,
wherein the optic coupled to the base and the one or more optics coupled to the mounting arm are configured to form an optical path for a beam produced by an interferometer sensor, and
wherein the optical path is configured to be used to determine a displacement of the platform in a vertical direction relative to an orientation of the nanopositioning system.

11. The nanopositioning system of claim 10, wherein the one or more optics coupled to the mounting arm include a first optic aligned with the optic coupled to the base in the vertical direction.

12. The nanopositioning system of claim 11, wherein the one or more optics coupled to the mounting arm includes a second optical component aligned with the optic coupled to the base in a direction orthogonal to the vertical direction, and a third optic substantially aligned with the second optic in the substantially vertical direction.

13. The nanopositioning system of claim 12, wherein the first and second optics coupled to the mounting arm are prisms and the third optic coupled to the mounting arm is a mirror.

14. The nanopositioning system of claim 10, wherein the optical path is configured not detect displacements in a horizontal direction that is orthogonal to the vertical direction.

15. A method for performing vertical displacement measurements for cryogenic interferometric stabilization in quantum information processing (QIP) systems, the method comprising:
aligning an interferometer sensor with a nanopositioning system positioned within a cryostat of the QIP system;
producing, with the interferometer sensor, a beam that travels along an optical path produced by one or more optics coupled to a movable platform of the nanopositioning system;
receiving, with the interferometer sensor, a reflected beam from the optical path;
determining a length of the beam path of the reflected beam; and
determining a displacement of the movable platform based on the length of the beam path of the reflected beam.

16. The method of claim 15, wherein the determined displacement of the movable platform is in a vertical direction relative to an orientation of the cryostat.

17. The method of claim 16, wherein the interferometer sensor is aligned with the nanopositioning system through a viewport having a field of view in a horizontal direction that is orthogonal to the vertical direction.

18. The method of claim 16, wherein the optical path is configured to be insensitive to displacement of the movable platform in a horizontal direction that is orthogonal to the vertical direction.

19. The method of claim 15, further comprising:
receiving information indicative of a disturbance in a position of the movable platform; and
commanding one or more actuators coupled to the movable platform to reposition the movable platform in response to the information indicative of the disturbance.

20. The method of claim 15, further comprising:
comparing the length of the reflected beam to a target beam length; and
commanding one or more actuators coupled to the movable platform to reposition the movable platform based in response to the comparison.
